(19) United States
(12) Patent Application Publication
(10) Pub. No.: US 2007/0154593 A1
(43) Pub. Date: Jul. 5, 2007

(54) Gadget for displaying advertising, containing papers for used chewing gum

(76) Inventor: Pavel Skarabela, Fr dek-Mistek (CZ)

Correspondence Address: LADAS & PARRY, 26 WEST 61ST STREET, NEW YORK, NY, 10023, US

(21) Appl. No.: 10/584,749

(22) PCT Filed: Apr. 3, 2003
(86) PCT No.: PCT/CZ03/00022

§ 371 Date: Jun. 20, 2006

(30) Foreign Application Priority Data
Mar. 13, 2003 (CZ) PUV 2003-14027

(51) Int. Cl. A23G 4/18

(52) U.S. Cl. 426/5

(57) ABSTRACT

The gadget for displaying advertising, containing papers for used chewing gum can be used in all catering, cultural, sports, educational and other locations, in public transport etc., and may also be offered when chewing gum is actually purchased. It provides opportunities for targeted advertising, and at the same time allows chewing gum users to hygienically and ecologically dispose of their gum by wrapping it in recycled paper and throwing it into a bin, a wastepaper basket or on the ground without it sticking to any surface.

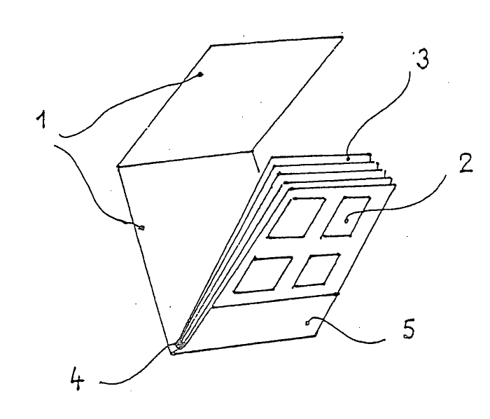

### TECHNICAL FIELD

The technical Field is related to human needs, being specifically a gadget for displaying advertising, containing papers for used chewing gum.

### BACKGROUND ART

Various gadgets are available for displaying advertising, but none of these gadgets contain papers for used chewing gum, which has now become a problem. It fouls pavements, roads, public transport, and catering, cultural, sport and educational facilities, among others. It sticks to shoes, carpets and pets' fur, and sometimes it is almost impossible to remove. This prevents the liquidation of used chewing gum and no method has yet been found to resolve this situation. The only option at present is to scrape it off, which is extremely unhygienic.

### DISCLOSURE OF INVENTION

The problems described above are solved to a significant extent by the gadget for displaying advertising, containing papers for used chewing gum. This comprises a cover with, at least on the outer side, a printed advertisement or company logo. Inside there are papers glued together on one edge, allowing a single piece to be torn off each time. The first of these papers carries printed pictograms. The papers are made of recycled paper. One part of the cover folds over to complete the package housing the inserted, glued papers. The idea is that when used chewing gum is wrapped in one of these papers and then disposed of in a bin, a wastepaper basket or, in the worst case, on the ground it will not stick and so can be liquidated in the usual way.

The gadget on the one hand enables targeted advertising and marketing sales support for companies engaged in, for example, catering services, but it also creates possibilities for public education by civic authorities, schools, cultural, sports and similar facilities as regards environmental protection, cleanliness and hygiene when disposing of used chewing gum. Just by tearing off one paper, wrapping up the used chewing gum and throwing it into a bin, a wastepaper basket or, in the worst case, on the ground.

The connection of these two aims is intentional, because the advertiser will cover the costs of the gadget and the chewing gum user will get the papers free of charge.

### BRIEF DESCRIPTION OF DRAWINGS

The technical solution is explained and described in detail in the attached drawing.

### DESCRIPTION OF THE PREFERRED EMBODIMENT

The gadget for displaying advertising, containing papers for used chewing gum is composed of a cardboard cover 1, which has, at least on its outer side, a printed black and white or colour advertisement or logo. Inside there are papers made from recycled material 3, glued together on one edge 4, allowing a single piece to be torn off each time. The front of the first piece has printed pictograms 2, functioning as a guide for their use, part of the cover 5 folds over to complete the package including the inserted, glued papers made from recycled material.

1. A gadget for displaying advertising, characterized in that its containing papers (3) for used chewing gum.

2. A gadget for displaying advertising as in point 1, characterized in that its being composed of a folded cover (1) and inserted papers (3) glued together on one edge (4) enabling a single piece to be torn off each time.

3. A gadget for displaying advertising as in point 1, characterized in that the cover being composed of cardboard.

4. A gadget for displaying advertising as in point 1, characterized in that its having at least on the outer surface of the folded cover (1) a printed advertisement or logo.

5. A gadget for displaying advertising as in point 1, characterized in that its having printed pictograms on the front surface of the first paper (2).

6. A gadget for displaying advertising as in point 1, characterized in that its having the inserted papers (3) made from recycled material.

7. A gadget for displaying advertising as in point 1, characterized in that its part (5) folding over to complete the package (1) with the inserted papers (3) made from recycled material.
